(19) United States
(12) Patent Application Publication
(10) Pub. No.: US 2010/0271252 A1
(43) Pub. Date: Oct. 28, 2010

(54) EASY TO USE UNIVERSAL REMOTE CONTROL

(75) Inventors: Rudy Musschebroeck, Wemmel (BE); Frank Amand, Leuven (BE); Jose Isidro Salgado Faria, Leuven (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/600,722

(22) PCT Filed: May 21, 2008
(86) PCT No.: PCT/IB2008/051990

§ 371 Date: Jun. 16, 2010

(30) Foreign Application Priority Data
May 25, 2007 (EP) 07108942.9

(51) Int. Cl. H04L 17/02

(52) U.S. Cl. 341/176

(57) ABSTRACT

A programmable remote control 10 for controlling at least one device 34-38 is provided and comprises a communication interface 12, 23, 24 for receiving a control script from a control script source 34, 36, and sending a control command to the at least one device 34-38. A user interface 11, 13, 14 enables a user to activate the control script, and a processing unit 21 is provided for upon activation by the user executing the control script for generating the control command.

### TECHNICAL FIELD OF THE INVENTION

The invention relates to a programmable remote control for controlling at least one device, the remote control comprising a communication interface for sending a control command to the at least one device, a user interface for enabling a user to provide a user command for controlling the at least one device and a processing unit for, upon the user command, sending the control command to the at least one device.

### BACKGROUND OF THE INVENTION

The Philips Pronto universal remote control learns infrared (IR) control commands from simple single device remote controls and uses WiFi for accessing metadata of streaming content on a local network to enable playback of the content by audio and/or video (A/V) devices. The Philips Pronto further uses WiFi for obtaining EPG (Electronic Program Guide) data from the Internet. An LCD touch panel and some hardware buttons are used for controlling a wide variety of equipment in an easy way. ProntoEdit software can be used for designing graphical user interfaces and assigning one or more functions to a button.

It is a problem of this universal remote control, that just imitating normal remote control commands does not fully satisfy the user's demands. A more flexible remote control is therefore desired.

Other remote controls are, e.g., provided by Creston and AMX. These companies offer custom automation solutions that allow universal remote control employing two-way feedback. These remote controls also use an LCD touch panel for providing status information concerning the devices and control elements, such as buttons, for controlling the devices. It is a problem of these remote controls that programming them takes considerable training and is therefore performed by specially trained engineers. A firmware upgrade is required for adding new features to the remote control.

### SUMMARY OF THE INVENTION

It is an object of the current invention to provide a remote control according to the opening paragraph and being more flexible and easier to use.

According to a first aspect of the invention, this object is achieved by providing a programmable remote control for controlling at least one device, the remote control comprising a communication interface for receiving a control script from a control script source and sending a control command to the at least one device, a user interface for enabling a user to activate the control script and a processing unit for upon activation by the user executing the control script for generating the control command.

The possibility to upload control scripts to the remote control enables the user to create or download scripts providing much more flexibility than merely providing a predetermined sequence of commands. The scripts may comprise all types of conditional statements that are available in the script language. Because of the use of a scripting language, the remote control only requires a single download of the script to make it available to the user. The remote control does not need a firmware upgrade to extend its possibilities. Its embedded software is already capable of interpreting and executing script language.

In a preferred embodiment, the communication interface is further arranged for receiving status information from the at least one device and the processing unit is arranged for using the status information as an input parameter for the control script and for generating the control command in dependence of the input parameter.

With this embodiment, conditional control behavior can be achieved depending on the status of the controlled device. Furthermore, the status information may inform the user about whether a script has been executed successfully. If not, the user may act accordingly. Alternatively the script may already comprise additional code for dealing with the ‘unexpected’ situation.

According to a second aspect of the invention, a system for controlling at least one device is provided, comprising a remote control as described above and a control box for relaying the status information from the at least one device to the communication interface of the remote control and/or for relaying the control command from the communication interface of the remote control to the at least one device.

A remote control, preferably, only comprises means for wireless communication, such as RF or IR communication means. Many devices only have interfaces for wired communication, such as RS232 or IP. The control box may function as a bridge between the remote control and the controlled devices. The control box communicates with the remote control via wireless communication and with the other devices via wired or wireless communication. Via the control box status information is sent to the remote control and control commands are sent to the devices.

These and other aspects of the invention are apparent from and will be elucidated with reference to the embodiments described hereinafter.

### BRIEF DESCRIPTION OF THE DRAWINGS

In the drawings:

FIG. 1 shows a programmable remote control according to the invention,

FIG. 2 shows a schematic representation of the inside of the programmable remote control of FIG. 1, and

FIG. 3 shows a system according to the invention.

### DETAILED DESCRIPTION OF THE INVENTION

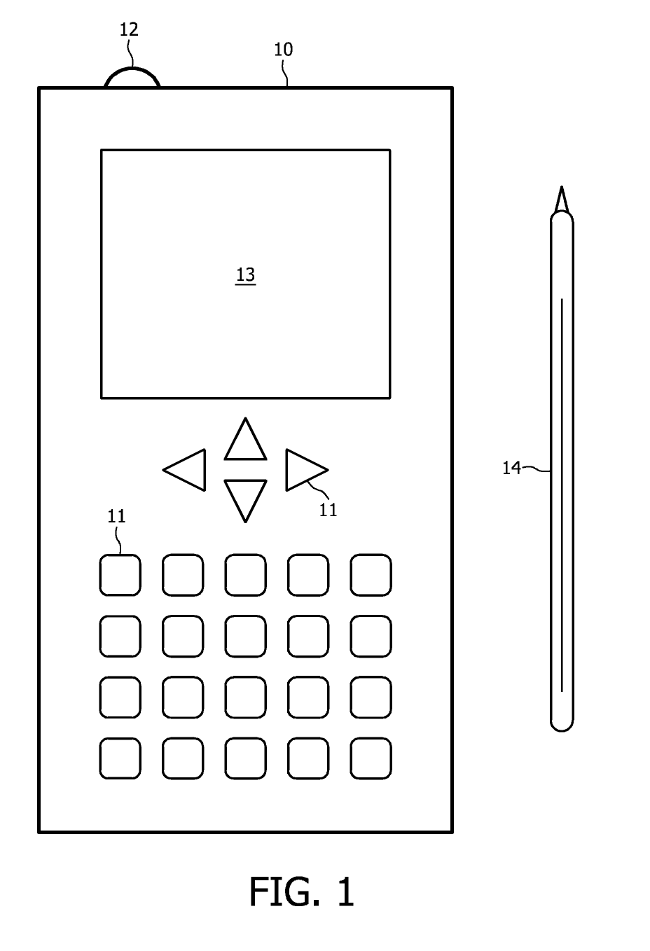

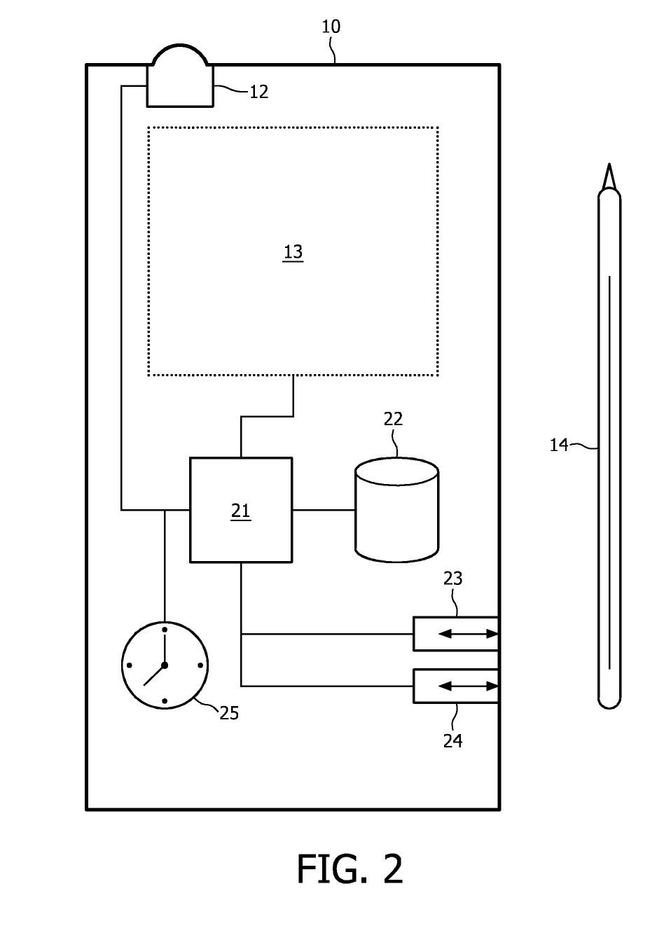

FIG. 1 shows a programmable remote control 10 according to the invention. The remote control 10 comprises buttons 11 for enabling a user to control one or more devices. The remote control 10 further comprises a display 13, e.g. an LCD, for providing feedback and/or instructions to the user. According to the invention, the display 13 is also used for showing status information from a device that is controlled by the remote control 10. The display 13 preferably is a touch screen and is used to provide a graphical user interface (GUI). On the touch screen, buttons and other user interface elements may be displayed. The user interface elements, such as buttons, sliders or check boxes, may be selected, activated, manipulated or controlled when touched by a user's finger. Optionally, a stylus 14 is provided for enabling the user to interact with the user interface with great precision. Depending on the design of the remote control 10, the user interface may comprise more hardware buttons 11 or may mostly rely on the GUI. The remote control 10 further comprises an infrared (IR) light emitting diode (LED) 12 for sending IR control signals to a controllable device. Further communication means are also part of the remote control 10 as will be elucidated below with reference to FIG. 2.

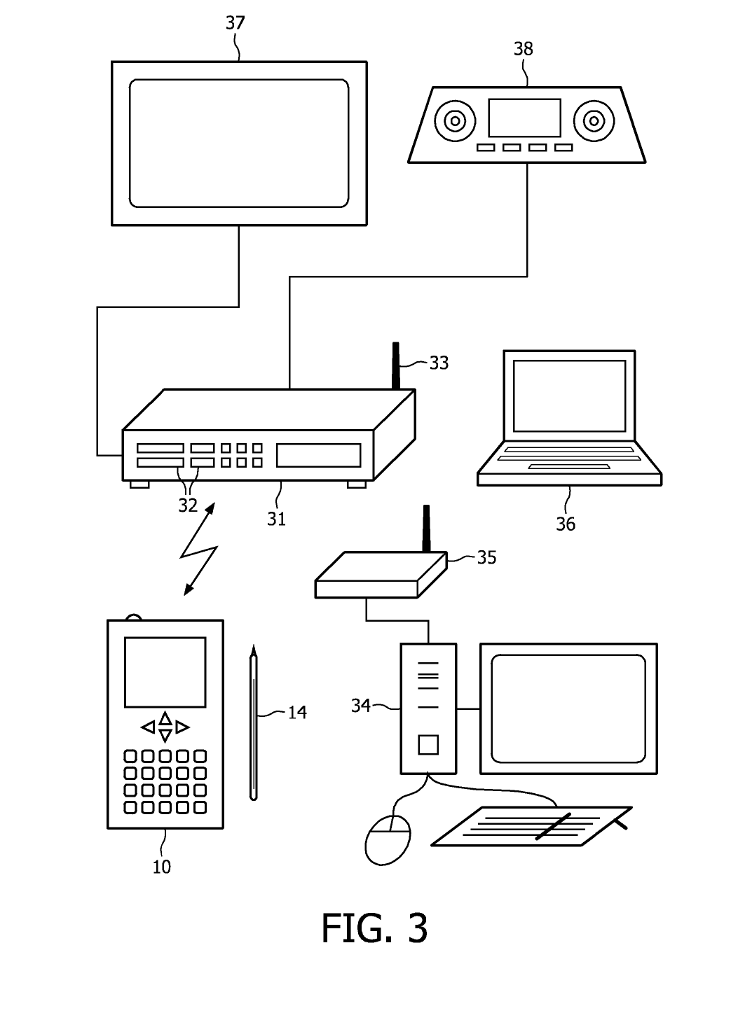

FIG. 2 shows a schematic representation of the inside of the programmable remote control 10. The remote control 12 comprises a processor 21 for processing the user input coming from the buttons 11 and/or the touch screen 13. The processor 21 is coupled to storage means 22, e.g. a solid state memory or a hard disk. The processor 21 is further coupled to one or more communication interfaces for sending and/or receiving information. For example, the IR LED 12 is provided for sending IR signals to a controllable device. The IR LED 12 is only capable of sending signals to other devices. Other communication interfaces, such as USB interface 23 and WiFi interface 24 may be arranged for sending as well as receiving signals. The control commands for controlling the devices are sent to the controllable devices directly or via a control box. The operation of the control box will be elucidated below with reference to FIG. 3.

According to the invention, at least one communication interface should be capable of receiving signals in order to receive control scripts. Control scripts may, e.g., be received from another remote control, or from a controllable device comprising device specific control scripts. Via, e.g., the USB interface 23, the remote control 10 may receive control scripts from a personal computer. The control scripts may be downloaded from the Internet, or written by the user. Preferably, a software tool is provided for allowing a user to design control scripts and upload the designed control scripts to the remote control 10. Such software may also allow the user to design the graphical user interface and assign control scripts to user interface elements.

Control scripts received at the remote control 10 are stored in the storage means 22. A control script may be assigned to a user interface element, causing the control script to be executed when the user interface element is activated. When the user, e.g., pushes a particular button 11 on the remote control 10, the control script assigned to that button 11 is executed. Alternatively, other events may initiate execution of a control script. For example, a control script may be executed at a predetermined moment in time. A timer 25 may be coupled to the processor 21, for enabling such time based triggering. Control scripts may also be triggered by one or more statuses of or commands from devices in the system. For example, a script may run when a CD player has finished playing a CD or when a telephone is ringing. A warning message may be displayed on the display 13 when the volume level of a radio exceeds a predetermined limit. Control scripts may also be triggered by combinations of events. For example, if it is a Sunday, 7 PM and the lights in the living room are on (probably somebody home), a control script is executed for turning on the TV in the living room, tuning in to a predetermined channel and setting the volume level to a predetermined value. Executing a script for changing to a particular TV channel may only occur when a button, assigned to the script, is pressed after 10 PM on weekday evenings. By allowing the user to design the control scripts himself and to choose the triggers or events that initiate execution of the control scripts, a highly flexible and powerful universal remote control 10 is provided.

Status information from the devices may be presented on the display 13 of the remote control 10. Preferably, pages showing such status information are frequently refreshed. The status information may influence the appearance of the GUI, e.g., by only showing relevant functions. For example, when a CD player is turned off, the GUI may only show one button for turning it on and a ‘pause’ button is not needed when no CD is being played. Status information of the devices in the system may be used as input parameter for a control script. The behavior of one device may thus be adapted to its status or to the status of other devices. For example, equalizer settings of an audio amplifier may depend on the channel to which the radio is tuned.

Several devices, e.g., a DVD player, a TV and an amplifier may all be turned on by pressing only one button. The control script assigned to said button may even tune the TV to the channel required for watching DVD, the volume level of the audio amplifier may be set to a predetermined value and the DVD may start playing a favorite part of the movie on the DVD. Setting a volume level or turning on lights may be done instantly or gradually.

FIG. 3 shows a system according to the invention. The system comprises a programmable remote control 10 as described above, a TV 37, a laptop 36, a digital radio 38, a personal computer 34 a wireless Internet router 35 and a control box 31. The IR LED 12 on the remote control 10 may be used for sending command signals directly from the remote control 10 to, e.g., the TV 37 or the digital radio 38. Alternatively, the command signals may be sent to the control box 31 and the control box 31 is coupled to the TV 37 and/or the radio 38 for passing the control commands from the remote control 10 to the controllable devices or for passing status information from the devices to the remote control 10. It is to be noted that such status information may also be sent directly from the devices to the remote control 10. The control box 31 comprises a plurality of connectors 32 for wired coupling of the control box 31 to all kinds of devices. The control box 31 may, e.g., comprise an RS-232 port or IP connection. The control box 31 may also comprise IR transmitter LEDs for controlling other devices. In this example, the control box 31 also comprises an antenna 33 for WiFi communication with a wireless network. The wireless network is set up by the wireless Internet router 35, which is connected to the Internet, the personal computer 34 and a laptop 36. The communication between the Internet router 35 and the personal computer 43 or laptop 36 may be wired or wireless. Preferably, the personal computer 34 uses a wired connection and the laptop a wireless WiFi connection. Optionally, an Internet router is comprised in the control box 31 and the separate Internet router 35 can be dispensed with. The control box 31 preferably communicates with the remote control 10 via WiFi, but may also comprise a photo diode for receiving the IR signals from the remote control 10 and/or from other devices.

Control scripts that are written by the user, using software running on the personal computer 34 or laptop 36, may be sent to the remote control via the WiFi network directly, via the control box 31, via a direct link (e.g. USB or WiFi) or via a USB memory stick. In an alternative embodiment, the control scripts are uploaded to the control box 31 and the control box is arranged for coupling remote control commands to the scripts. Uploading scripts to the control box 31 may be performed by the computer 34, the laptop 36 or the remote control 10. An advantage of running scripts at the control box 31 may be that the control box 31 is mains powered and hence can monitor external events while the remote control 10 saves battery power and may go to sleep. However for scripts that influence the appearance of the GUI on the display 13 of the remote control 10, it is much easier when the scripts are executed by the processor of the remote control 10 itself. The scripting software may be a standard PC text editor or a special program for programming the GUI and behavior of the remote control 10. The programming of the remote control systems will be done by means of using a script language. Preferably, a well known script language, such as JavaScript, is used. Scripts can be assigned to GUI elements at various logical levels:
at the level of a button or key, meaning that the script will be executed whenever a button is pressed
at the level of a page, meaning that the script will be executed upon activation of that page
at the level of a page group, which we also call “Activity” or “Module”
at the level of a page timer, meaning that the script will be executed whenever this timer expires
combinations of the above

The scripting language that is offered to the programmer preferably gives access to all relevant APIs in order to program modules that effectively make use of these interaction means, both for reading and writing to these outputs. The scripting language shall for example give the possibility to send classical IR codes, enable IP communication with any networked device, offer the possibility to communicate over RS232 ports, set relay outputs and read from sensor inputs. By offering this possibility the scripted control module will be capable of reading out status information of the controlled device. All these commands, even to different devices using different interfaces or protocols can be combined in a single script which delivers true system integration. A single script could combine functionality of, e.g., an advanced 2-way HVAC thermostat and a classical IR based lighting system

The control scripts may also comprise code for obtaining data from a data storage in the local network or from accessible external data sources. For example, a control script may enable a user to browse through meta information of music files stored on a computer in the network or the control script may allow reading EPG information or RSS feeds obtained from the Internet.

The scripting language preferably also provides access to relevant internal system resources such as system timers, internal memory for storage of variables, IR codes, graphics and sounds stored inside the systems configuration file, internal system variables such as battery level, RF signal strengths, time and date and the log file of the system. The scripts can then use timers to trigger actions. The script can store data and variables in memory for later use to make the behavior of the remote control dependent on its usage history. Scripts can access information stored in memory such as IR codes in order to transmit them to controllable devices. Scripts can make their behavior dependent on time of day, battery level etc. Scripts can output information to the log file of the system which enables basic debugging of a script by a script developer. It may also be possible to run scripts in a debugging mode, wherein all steps of the script are performed one by one, such that the user is able to exactly see what actions are performed in which order.

The scripts may also be programmed to adjust the GUI as displayed on the display 13. It may be possible for the scripts to change text labels on buttons or frames, modify bitmaps of buttons and frames, hide and make visible graphical assets on the screen, move/animate graphical assets or change background images. The scripts can use the GUI to inform the user of status information. The otherwise completely static user interface can become dynamic by enabling animations involving changing appearances and moving of objects. The script may also offer the possibility to playback sounds on a remote control with sound playback capabilities.

An exemplary control script could run in such a way that a one-button press could initiate a “Listen to Music” activity in a particular room, whereby the control system performs following actions:
The script uses the system timer 25 to determine the time of day.
Depending the time of day the lights will be set to a certain dim level in this room. To do that the system will use a serial interface to communicate with the lighting controller to find out current status of the light level in this room.
To avoid a big-bang light on, the script will adapt the dim level in a gradual way towards the desired level (by using a for loop for e.g.)
Using a power sensor, the script will now check the status of the audio amplifier in this room. If it is not yet on, the right IR code will be sent to the amplifier to turn it on. The same is done for the digital radio 38.
Using serial communication the input source and volume level will be checked and then set to ensure the amplifier is set to the digital radio input at right volume level
Now the lights are set and music is playing, the remote control system makes sure the user goes to a status screen where the users sees his system information:
   The present volume level is shown based on serial feedback from the amplifier
   Music metadata information—including artist name and album cover art—is shown about the currently playing song, obtained by using IP communication with the internet radio device or internet radio service
Using the page timer, the information is refreshed every 3 seconds for as long as the user does not navigate to another page on the user interface.
It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the claims enumerating several means, several of these means may be embodied by one and the same item of hardware. The mere fact that certain measures are recited in mutually different dependent claims does not indicate that a combination of these measures cannot be used to advantage.

1. A programmable remote control 10 for controlling at least one device 34-38, the remote control 10 comprising
a communication interface 12, 23, 24 for
receiving a control script from a control script source 34, 36, and
sending a control command to the at least one device 34-38,
a user interface 11, 13, 14 for enabling a user to activate the control script, and
a processing unit 21 for upon activation by the user executing the control script for generating the control command.

2. A programmable remote control 10 as claimed in claim 1, further comprising a display 13, the communication interface 12, 23, 24 further being arranged for receiving status information from the at least one device 34-38 and the processing unit 21 being arranged for displaying the status information on the display 13.

3. A programmable remote control 10 as claimed in claim 1, wherein the communication interface 11, 13, 14 is further arranged for receiving status information from the at least one device 34-38 and wherein the processing unit 21 is arranged for using the status information as an input parameter for the control script and for generating the control command in dependence of the input parameter.

4. A programmable remote control 10 as claimed in claim 1, wherein the user interface 11, 13, 14 comprises a graphical user interface and wherein the control script comprises code for changing the graphical user interface.

5. A programmable remote control 10 as claimed in claim 4, wherein execution of a further control script is triggered by the changing of the graphical user interface.

6. A programmable remote control 10 as claimed in claim 1, further comprising a timer 25 for triggering execution of the control script.

7. A programmable remote control 10 as claimed in claim 1, further comprising a timer 25 for providing a current time as a further input parameter for the control script.

8. A programmable remote control 10 as claimed in claim 1, further comprising a debugger for enabling step by step execution of the control script.

9. A programmable remote control 10 as claimed in claim 1, wherein the processing unit 21 comprises a JavaScript engine.

10. A programmable remote control 10 as claimed in claim 1, wherein the communication interface 12, 23, 24 is arranged for sending and/or receiving data using USB and/or IR and/or WiFi.

11. A system for controlling at least one device 34-38, comprising
a programmable remote control 10 according to claim 1 and
a control 31 box for relaying the status information from the at least one device 34-38 to the communication interface 12, 23, 24 of the remote control 10 and/or for relaying the control command from the communication interface 12, 23, 24 of the remote control 10 to the at least one device 34-38.

12. A system for controlling at least one device 34-38 as claimed in claim 11, further comprising the control script source 34, 36 for sending the control script to the remote control 10.

13. A system for controlling at least one device 34-38 as claimed in claim 12, wherein the control script source is a computer 34, 36, running software for enabling the user to associate an element of the user interface 11, 13, 14 of the remote control 10 with the control script.

14. A system for controlling at least one device 34-38 as claimed in claim 13, wherein the software further enables the user to create or edit a control script.

15. A system for controlling at least one device 34-38 as claimed in claim 13, wherein the user interface 11, 13, 14 comprises a graphical user interface 13, 14 and wherein the software further enables the user to create or edit the graphical user interface 13, 14.
